(19) United States
(12) Patent Application Publication
(10) Pub. No.: US 2014/0264055 A1
(43) Pub. Date: Sep. 18, 2014

(54) SYSTEM AND PROCESS FOR DETECTING PHOSPHONATE

(71) Applicant: Advantage Controls, LLC, Muskogee, OK (US)

(72) Inventors: Richard Morris, Muskogee, OK (US); Kaveh Ashenayi, Tulsa, OK (US); Peter LoPresti, Tulsa, OK (US); Jonathan Torkelson, Tulsa, OK (US)

(73) Assignee: Advantage Controls, LLC, Muskogee, OK (US)

(21) Appl. No.: 14/212,206

(22) Filed: Mar. 14, 2014

Related U.S. Application Data
(60) Provisional application No. 61/790,815, filed on Mar. 15, 2013.

(51) Int. Cl. G01N 21/59

(52) U.S. Cl. CPC G01N 21/59
USPC 250/373

(57) ABSTRACT

The invention is generally a system and process for detecting phosphonate. The system and process detect and monitor phosphonate using optical, electronics and analytical software technology in a side stream to measure the level of phosphonate in the stream and then calculate the amount of the proper chemicals to inject into a cooling tower or boiler to prevent scale, rust and corrosion.

### CROSS REFERENCE TO RELATED APPLICATIONS

This application claims the benefit of U.S. Provisional Patent Application No. 61/790,815, filed Mar. 15, 2013, which is incorporated herein by reference.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A SEQUENCE LISTING, A TABLE, OR A COMPUTER PROGRAM LISTING APPENDIX

Not Applicable.

### BACKGROUND OF THE INVENTION

1. Field of the Invention

This invention relates generally to a system and process for detecting phosphonate, and in particular to a system and process for detecting phosphonate using optical, electronics and analytical software technology in a side stream to measure the level of phosphonate in the stream and then calculate the amount of the proper chemicals to inject into a cooling tower or boiler to prevent scale, rust and corrosion.

2. Description of the Related Art

Cooling towers and boilers are dynamic pieces of equipment, and as such, one of the biggest challenges is proper dosing of chemical treatments. Over the years, numerous methods have been attempted to successfully protect cooling towers and boilers from the harmful effects of corrosion and fouling. The most successful approach involved the use of chromate based treatments. The actual chromate levels could be controlled using a colorimeter-based measurement that would be tied to a feed pump. Chromates were determined to be an environmental threat though, and have been banned in the United States for the past thirty years.

Phosphonates are currently widely used as the main ingredients for corrosion protection and scale prevention in cooling towers and boilers, and are also used for chelation and fouling prevention in these and other applications, such as peroxide bleach stabilization. Present methods for controlling the application of phosphonates in these systems employ indirect methods that are processing intensive, may require extensive chemical handling, and require lengthy time periods to execute. For example, most treatments are fed in to the system based on the amount of untreated water entering the system, and spot checking is used to determine the actual levels of phosphonate treatment. From these spot checks, feed rates are increased or decreased accordingly. These spot checks are insufficient to accurately treat the dynamic nature of the system, and therefore the usual approach is to over-feed the treatment, which is economically preferable to allowing the possibility of scaling or corrosion. The cost of the approach, however, is preferred to the cost of replacing or repairing damaged equipment. These aspects of current methods make them much less than ideal for timely execution of control methods to maintain cooling towers and boilers at optimal operating conditions.

Traditionally, the determination of phosphonate concentrations has been carried out by a variety of predominantly chemical methods. These methods include titration-based methods, ion-chromatography followed by post-column reaction with Fe(III), post-column oxidation of phosphonate to phosphate and detection of phosphate with the molybdenum blue method, ion-chromatography with pulsed amperometric detection of amine-containing phosphonates, ion-chromatography with indirect photometric detection, and capillary electrophoresis with indirect photometric detection. All of these detection methods are limited to minimum sensitivities in the 2 to 10 μM range. An ion-pair high-performance liquid chromatography (HPLC) method with pre-column formation of Fe(III) complexes has been demonstrated to measure 50 nM concentrations in natural waters and wastewaters, but is not able to quantify bisphosphonic acids, such as HEDP (1-hydroxyethane 1,1-diphosphonic acid), which is one of the most used phosphonates in cooling towers. Anion-exchange chromatography is useful for analyzing chelating agents such as phosphonates, with sensitivities again in the nM range; however, it does require analytical methods that contain many analytical steps that must be carried out in a laboratory setting to obtain accurate measurements and take up to an hour to complete, and thus are not suitable for real-time process control.

Several predominantly electrically-based approaches have been proposed and/or demonstrated to measure phosphonate concentrations. One such approach is the quartz crystal microbalance (QCM), also known as a quartz crystal resonator. The essence of this device is a quartz crystal that can be made to oscillate through electrical stimulation. The oscillation is sensitive to the mass of material adsorbed onto the surface of the QCM. Since phosphonates are soluble in water, the surface of the QCM must be coated with a material that adsorbs phosphonates onto the QCM in order for the sensing mechanism to function. Example coating materials include silica thin films, 11-mercaptoundecanoic acid, and aerogels. A similar sensor is based on surface acoustic wave (SAW), but has been hampered by issues with sensitivity and difficulties in depositing the material coatings. Another approach uses indium-tin oxide (ITO) coated glass to make electrical contacts with the phosphonate that can be potentially exploited for both sensing and organic electronic applications. This method takes advantage of phosphonates strong adsorption onto surfaces containing metals or metallic oxides to create phosphonate monolayers. The current-voltage (I-V) curve for a phosphonate layer sandwiched between two electrodes varies for different phosphonate materials. Drawbacks of this method include hysteresis in the I-V curve, current amplitudes of only a few hundred nanoamps, and poor understanding of the charge transport mechanism between the electrodes and the monolayers.

A number of optical approaches have also been proposed and demonstrated to measure phosphonate concentrations in a variety of solutions. Most phosphonates have distinct absorption signatures in the mid to far infrared (IR) (wavelengths ranging from 2-12 μm), even in water-based solutions. To detect this signature in detail, the Fourier Transform Infrared (FTIR) spectroscopy method was applied. In this method, light from a broadband source is filtered to allow different combinations of wavelengths to pass through the sample and the absorption for each different combination is measured. A computer then uses Fourier Transform methods to reconstruct the absorption spectra from the multitude of measurements. While very effective, this method requires an expensive FTIR spectrometer (over $50,000) to perform the analysis, or wideband quantum cascade lasers (over $20,000), and thus the method is not practical for implementation at numerous sites in the field.

Another approach is to mark the phosphonates, their byproducts, or materials they interact with, using fluorescent compounds or dyes. The fluorescent material is activated when stimulated by an optical source at an appropriate wavelength, causing the material to emit light at a characteristic wavelength. The phosphonate concentration can be determined by measuring the total light intensity collected from all of the fluorescing phosphonate compounds or by measuring the quenching of the fluorescence (i.e., the decrease in fluorescence with time) caused by interacting with certain materials, such as lipases. The weak nature of the fluorescence and the need to filter background light sources requires fluorescence detectors and related measuring equipment or spectrophotometers.

A third method is the fiber-optic, surface-enhanced Raman spectroscopy (SERS) sensor, which was originally developed to detect trace quantities of warfare agents in water but is readily adaptable to measuring phosphonates. The sensor uses a fiber optic cable with a specially prepared end that is first coated with silver or other metal and then an organic coating is deposited on top of the metal layer. The organic coating is chosen to encourage adsorption of the target agent onto the surface. High intensity light at an appropriately chosen wavelength (e.g., 702 nm from a Ti:Sapphire laser) is needed to excite Raman scattering at the end surface of the fiber, and the scattered light is collected by the fiber for analysis, commonly carried out with a commercial dispersive Raman spectrometer. In all of these methods, the instrumentation required is prohibitive in cost and better suited to a laboratory environment than a typical field environment.

Phosphonates are broken down in the natural environment by means of photodegradation. A study by Lesueur, et al. placed several different phosphonates (NTMP (N-tris(methylene phosphonic acid)), EDTMP (ethylenediamine tetra(methylene phosphonic acid)), DTPMP (diethylenetriamine penta(methylene phosphonic acid)) and HDTMP (hexamethylenediamine tetra (methylene phosphonic acid)) in distilled water along with concentrations of iron (III), typical of natural waters. The sample pH was adjusted from 3 to 10 using sulfuric acid or sodium hydroxide. The phosphonates formed Fe(III) complexes with the iron (III), which absorb significantly in the ultraviolet (UV) range and underwent photodegradation. Uncomplexed phosphonate exhibited less UV absorption and only low rates of photodegradation. In the Lesueur, et al. study, aqueous solutions of several different phosphonates at a concentration of 1 mg/L, with and without iron (III), were then exposed to radiation from one of two UV lamps that contained significant irradiation flux between 100 nm through 380 nm, covering the entire range from UVC to UVA. To monitor the photodegradation, laboratory analysis was carried out to determine the level of two degradation byproducts, orthophosphates (PO₄³⁻) and AMPA (2-amino-3-(3-hydroxy-5-methyl-isoxazol-4-yl)propanoic acid), as a function of the UV exposure time. The analysis showed that photodegradation occurred with and without the formation of Fe(III) complexes, and that the rate of photodegradation significantly increased with the presence of iron (III). In particular, the increase in the photodegradation rate afforded by iron (III) became more significant as the pH became more acidic, with a factor of 2.5 to 3 increases in the rate observed at pH 3. The phosphonate half-life was between 5 and 10 minutes for all of the phosphonates tested, which would provide sufficient time to make effective control decisions for the targeted cooling tower and boiler applications, and is significantly less time than that required for the standard sensing methods developed previously. In general, the phosphonates with a higher number of phosphonate functional groups degraded faster, though one exception was observed.

It is therefore desirable to provide an improved system and process for detecting phosphonate.

It is further desirable to provide a system and process for detecting phosphonate using optical, electronics and analytical software technology in a side stream to measure the level of phosphonate in the stream and then calculate the amount of the proper chemicals to inject into a cooling tower or boiler to prevent scale, rust and corrosion.

It is yet further desirable to provide a system and process for detecting phosphonate that measures the photodegradation of phosphonates over time and the UV absorption characteristics for different commercial phosphonates concentrations, and then combining the measurements to determine the concentration of phosphonates within a sample.

It is still further desirable to provide a system and process for detecting phosphonate that quickly measure with minimal processing the presence and concentration of specific phosphonate compounds contained in the water of a cooling tower.

It is yet further desirable to provide an on-line phosphonate monitor that monitors and doses the treatment chemicals for cooling towers and boilers.

It is still further desirable to provide a system and process for detecting phosphonate that utilizes UV and IR radiation to target specific properties of phosphonates that are more easily measurable on site.

It is still further desirable to provide a system and process that targets the optical properties of phosphonate and that do not require extensive chemical or material processing to extract the required information or complex optical instrumentation, thereby greatly reducing the cost, complexity and processing time of the sensing system and process so that critical control information can be more quickly and effectively acted upon.

It is yet further desirable to provide an improved system and process for detecting and monitoring phosphonate concentrations within a cooling tower or boiler to allow better regulation of the concentration, thereby maximizing the positive effects of phosphonates in preventing scaling, fouling, and corrosion.

It is still further desirable to provide a system and process for improved regulation of phosphonate concentrations to reduce costly over-dosing of chemical treatments, which in turn minimizes the potential for negative environmental effects from the release of these recalcitrant compounds into the environment.

### BRIEF SUMMARY OF THE INVENTION

In general, in a first aspect, the invention relates to a system and process for detecting phosphonate. The system includes a sampling subsystem having a sampling chamber in fluid communication with a water cooling tower to extract a side stream to be used for a concentration measurement. The system also includes a processing subsystem having at least one optical source and a corresponding receiver capable of measuring transmitted optical energy. The system can also include a fresh water supply used to wash the sampling chamber to prevent any potential cross contamination. Further, the system can also include a first stage absorption detection subsystem and a second stage photodegradation detection subsystem. In addition, the system can include a set of electronically controlled solenoid valves in fluid communication with the side stream and/or at least one mechanical fixture joined to the optical source and the receiver ensure placement repeatability with respect to the sampling chamber. The optical source may be a plurality of optical sources, and the receiver may be a plurality of receivers. Moreover, each of the optical sources can emit ultraviolet light at differing frequencies.

The system and process disclosed herein can further include an optional reference signal for calibration, with calibration being accomplished using onboard, auto calibration circuitry or manual calibration circuitry. The receiver may use a powered reverse biased configuration, and the optical source may be an optimized LED source that emits at wavelengths of between about 285 nm and about 395 nm. In addition, the system and process may utilize a temperature sensor to compensate for thermal effects within the sampling chamber. The sampling subsystem and the processing subsystem of the system can be encased in a waterproof enclosure. Further, a plurality of electrical relays to activate external devices, such as pumps or power supplies, may be provided, such as at least one external interface, at least one serial communication link and/or a switch to set high and low limits parameters and/or timed operation parameters. Moreover, the system can utilize a microprocessor for control logic for the sampling subsystem and analysis logic for the processing subsystem.

In general, in a second aspect, the invention relates to a process for determining a phosphonate concentration in a water cooling tower. The process includes the steps of (a) extracting a water sample from a water cooling tower using a sampling subsystem, (b) mixing an iron salt (e.g., an iron (III) salt) with the water sample in the sampling subsystem, (c) illuminating the mixture of the iron salt and the water sample with optical energy using a processing subsystem, and (d) determining the phosphonate concentration using the processing subsystem based on photodegradation of the optical energy through the mixture. The optical energy has a predetermined intensity and is emitted at a predetermined wavelength, such as between about 285 nm and about 395 nm. The process can also include flushing the sampling subsystem with a supply of fresh water.

The process can also include detecting a first stage absorption of the mixture of the iron salt and the water sample using a low intensity optical energy from the processing subsystem, followed by detecting a second stage photodegradation of the optical energy through the mixture using a high intensity optical energy from the processing subsystem. The low intensity optical energy can have a wavelength between about 285 nm and about 355 nm, and the high intensity optical energy can have a wavelength between about 285 nm and about 395 nm.

The sampling subsystem may include a sampling chamber in fluid communication with the water cooling tower to extract the water sample from a side stream. The processing subsystem may include at least one optical source and a corresponding optical receiver for determining the photodegradation of the optical energy through the mixture. The step of illuminating the mixture during the process can further include illuminating the mixture of the iron salt and the water sample with ultraviolet light at differing frequencies using an LED optical source of the processing subsystem. For example, the LED optical source emits at wavelengths of between about 285 nm and about 395 nm, and/or the LED optical source is a plurality of optimized LED optical sources emitting at differing wavelengths of between about 355 nm and about 395 nm.

### BRIEF DESCRIPTION OF THE DRAWINGS

FIG. 1 illustrates an example of a sensor in accordance with an illustrative embodiment of the system and process for detecting phosphonate disclosed herein;

FIG. 2A schematically illustrates an illustrative embodiment of the system and process for detecting phosphonate disclosed herein;

FIG. 2B schematically illustrates another illustrative embodiment of the system and process for detecting phosphonate disclosed herein;

FIG. 3 illustrates an example of a sensor that measures photodegradation via changes in absorption in accordance with an illustrative embodiment of the system and process for detecting phosphonate disclosed herein;

FIG. 4 illustrates an example of absorption monitoring using a sensor having multiple UV sources in accordance with an illustrative embodiment of the system and process for detecting phosphonate disclosed herein;

FIG. 5 is a schematic for an example of electrical circuitry for a power supply for the sensor and relay controls for external devices in accordance with an illustrative embodiment of the system and process for detecting phosphonate disclosed herein;

FIG. 6 is a schematic for an example of electrical circuitry for a microprocessor for the sensor in accordance with an illustrative embodiment of the system and process for detecting phosphonate disclosed herein;

FIG. 7 is a schematic for an example of electrical circuitry for a serial communication interface for the sensor in accordance with an illustrative embodiment of the system and process for detecting phosphonate disclosed herein;

FIG. 8 is a schematic for an example of electrical circuitry for a display for the sensor in accordance with an illustrative embodiment of the system and process for detecting phosphonate disclosed herein;

FIG. 9 is a schematic for an example of electrical circuitry for a keypad and configuration switches for the sensor in accordance with an illustrative embodiment of the system and process for detecting phosphonate disclosed herein;

FIG. 10 is a schematic for an example of electrical circuitry for an analog isolation circuit for the sensor in accordance with an illustrative embodiment of the system and process for detecting phosphonate disclosed herein;

FIG. 11 is a schematic for an example of electrical circuitry for a first sender output circuit for the sensor in accordance with an illustrative embodiment of the system and process for detecting phosphonate disclosed herein;

FIG. 12 is a schematic for an example of electrical circuitry for a second sender output circuit for the sensor in accordance with an illustrative embodiment of the system and process for detecting phosphonate disclosed herein;

FIG. 13A is a schematic for an example of electrical circuitry for a system input for the sensor in accordance with an illustrative embodiment of the system and process for detecting phosphonate disclosed herein;

FIG. 13B is a schematic for an example of electrical circuitry for a system input for the sensor with data conditioning in accordance with an illustrative embodiment of the system and process for detecting phosphonate disclosed herein;

FIG. 14 is a schematic for an example of electrical circuitry for an LED optical source for the sensor in accordance with an illustrative embodiment of the system and process for detecting phosphonate disclosed herein;

FIG. 15 is a flow chart for sensor firmware in accordance with an illustrative embodiment of the system and process for detecting phosphonate disclosed herein;

FIGS. 16A and 16B are plots of output voltage versus phosphonate concentration for two different wavelengths using the absorption approach: (A) 385 nm wavelength; and (B) 355 nm wavelength; and

FIGS. 17A and 17B are plots of output voltage versus phosphonate concentration for two different wavelengths using the absorption approach: (A) 355 nm wavelength; and (B) 335 nm wavelength.

Other advantages and features of the invention are apparent from the following description and from the claims.

### DETAILED DESCRIPTION OF THE INVENTION

The processes and systems discussed herein are merely illustrative of specific manners in which to make and use this invention and are not to be interpreted as limiting in scope.

While the processes and systems have been described with a certain degree of particularity, it is to be noted that many variations and modifications may be made in the details of the sequence and the arrangement of the processes and systems without departing from the scope of this disclosure. It is understood that the processes and systems are not limited to the embodiments set forth herein for purposes of exemplification.

The invention relates generally to a system and process for detecting phosphonate, and in particular to a system 10 and related process for detecting phosphonate using optical, electronics and analytical software technology in a side stream 12 to measure the level of phosphonate in the stream 12 and then calculate the amount of the proper chemicals to inject into a cooling tower or boiler 14 to prevent scale, rust and corrosion. As shown in FIG. 1, the system 10 disclosed herein includes and the process utilizes a sensor 16 having electronics and control systems 18, optical sources 20, optical detectors 22, and any material repositories 24 enclosed in a protective enclosure 26 that is mounted on or next to the side of the cooling tower 14. During operation, samples from the cooling tower 14 are taken through the side stream 12 via a tube or similar conduit 28 fluidly connected to the tower 14 by at least one solenoid valve 30. The sampled water enters a sampling chamber 32 where the sensing process occurs, along with any treatments required as part of the sensing process. The sampling chamber 32 of the sensor 16 is designed so that only periodic cleaning of the chamber 32 is required to maintain the integrity of the sensing process. As illustrated in FIGS. 2 and 3, a transparent plate or conductive substrate 34 provides an adsorption focus 35 for the phosphonates present in the water sample. Depending on the particular sensing process utilized, an agent material is required to either promote adsorption or enhance other properties of the phosphonates exploited by the sensor 16. This agent, which is stored in an agent repository 36, is added (via an automated system or manual) through a tube or conduit 38 (if liquid) or drop hatch (if solid) located near the top of the sampling chamber 32. Optical interrogation of the adsorbed phosphonates is carried out using the one or more sources 20 and detectors 22 driven by the electronics and control systems 18 having electronic driver and processing circuits. After processing of the sample material concludes, the material is drained from the chamber 32. The sampled and treated water is handled and disposed of appropriately, according to local, state, and federal guidelines.

Turning now to FIG. 4, the sensor 16 includes a main processing board 40 and a power supply 42. The main processing board 40 is in communication with external communication lines 44 and a series of relays 46 (R#1, R#2, R#3 and R#4). The relays 46 are in communication with an external chemical pump 48 and an agent pump 50. The agent pump 50 is in fluid communication with the agent repository 36 and in fluid communication with the sampling chamber 32 via conduit 38. The sampled water is passed from the cooling tower water loop 14 through conduit 28 to the sampling chamber 32. As illustrated, the flow of sampled water can be controlled using a serial of manual shut off valves 52a/b that allow for selective sampling using a manual sampling valve 54. During normal operations, the sampled water flows from the tower 14 via conduit 28 through an upstream solenoid valve 30a filling the sampling chamber 32, and the sampled water flow is selectively stopped using a downstream solenoid valve 30b positioned downstream of the sampling chamber 32. The upstream solenoid valve 30a and the downstream solenoid valve 30b are respectively powered using switched solenoid power lines 56 via the relays 46.

The electronics and controls systems 18 for the sensor 16 of the system 10 can comprise two (2) subsystems: a data acquisition subsystem and a data analysis subsystem. The data acquisition subsystem controls the valves (e.g., solenoid valves 30a/b) and pumps (e.g., agent pump 50) needed to sample and hold water from the main loop 14 for evaluation. In addition, the data acquisition subsystem provides the drive signal to energize the UV light source 20 comprising a plurality of LED light sources 58 and reads the output of the UV detectors 22. The UV detectors 22 comprise a plurality of LED light receivers 60, equal in number to the LED light sources 58. The analog signal from the UV detectors 22 is then be converted using the sensor 16 to a digital signal and processed by the data analysis subsystem to produce a numerical value representing the phosphonate concentration in the water.

By way of example, not limitation, the sensor 16 includes a plurality of suitable electrical circuitry, including a power supply circuit (FIG. 5) for the sensor and relay controls for external devices, a microcontroller or microprocessor circuit (FIG. 6), a serial communication interface circuit (FIG. 7), a display circuit (FIG. 8), a keypad and configuration switches circuit (FIG. 9), an analog isolation circuit (FIG. 10), a first sender output circuit (FIG. 11), a second sender output circuit (FIG. 12), a system input circuit (FIG. 13A), a system input circuit with data conditioning (FIG. 13B), and an LED optical source circuit (FIG. 14). The circuits of the sensor 16 are in communication with the microcontroller or microprocessor 40, and each of the circuits of the sensor 16 includes suitable electrical components; for example, as illustrated, resistors (R1-R79), capacitors (C1-C86), diodes (D1-D13), fuses (F1-F4), jacks (J1-J9), inductors (L1-L10), power supplies (PS1-PS3), transistors (Q1-Q9), switches (S1-S2), transformers (T1-T12), integrated circuits (U1-U26), test points (TPICT1-TPICT50), and crystal (Yl).

By way of further example, the sensor 16 of the system 10 and process disclosed herein may use the central microprocessor 40 to control the overall operation of the system 10 and a system bus that connects the central processor 40 to one or more conventional components, such as a network card or modem, via the external communication lines 44. The sensor 16 may also include a variety of interface units and drives for reading and writing data or files. Depending on the type of device, the user could interact with the system 10 using a keyboard, pointing device, microphone, pen device or other input device. The sensor 16 may be connected to a remote computer via a suitable network connection, such as a phone line, T1 line, a common local area network (“LAN”) or other mechanism for connecting computer devices. Data storage electronics, such as serial flash memory, permits storage of audio files, data files, concentration readings and other information. Further, the system 10 may include other suitable interface connectors, such as a multi-pin plug, USB, Bluetooth, etc.

Referring now to FIG. 15 illustrating a flow chart of an example of firmware, the system and process 10 disclosed herein may have a display and input devices (e.g., keyboard and/or mouse allowing a user to select menu options as well as enter values) used to display the menu options as well as displaying values and graphs as desired. When the user starts the process for detecting phosphonate, the system 10 performs an initial hardware check and initializes all variable using any stored values. The system 10 fills the sampling chamber 32 with water from the side stream 12, and then adds the agent, namely an iron solution, to the sample. After a first predetermined amount of time, the system 10 takes a first reading and displays the value, along with displaying any other values or active alarms. The value is the output using the output form selected by the user. After a second predetermined amount of time has elapsed since the first reading, such as 30 seconds, the system and process 10 reset or display the last value reading and all active alarms.

The system 10 and process disclosed herein may utilize a continuous stream methodology or a sample and hold methodology, wherein the side stream 12 is used to sample the water in the main loop 14 and hold for evaluation. The sample in the side stream 12 is mixed with the agent, namely Fe(III) salt, and the mixture is exposed to the UV light source 58. The amount of UV light received is measured at the receivers 60, and a numerical value is generated to represent the phosphonate concentration based on how much UV light was received.

The system 10 and process utilizes one or more UV light sources 58, such as up to four (4) UV light sources, with each light source 58 operating simultaneously at the same or different frequencies. The plurality of light sources 58 allows for multiple reads, which are averaged for each respective frequency, thereby eliminating any outliers from the calculations, or differences in frequency response can be used to confirm a given numerical value. Also, any high-frequency variations that may exist due to noise in the system 10 can be eliminated in order to yield a more accurate result.

The system 10 and process for detecting phosphonate may utilize the microprocessor 40 for signal conditioning as well as optical isolation to protect both the data acquisition subsystem and the data analysis subsystem from stray electrostatic charges. Upon completion of the detection process, the sample in the side stream 12 is discarded, according to local and federal guidelines, from the sampling chamber 20 to a drain 62 through the downstream solenoid valve 30b.

The system and process for detecting phosphonate 10 disclosed herein may be absorption based, photodegradation based and/or a combined absorption and photodegradation integrated into a single sensor 16 to exploit the advantages of each methodology and achieve an accurate and rapid assessment of phosphonate concentrations within the sample under test. For example under the later methodology, the system and process 10 can make a first stage absorption detection as a rapid means of estimating the phosphonate concentration and then make a subsequent second stage photodegradation detection to refine the measurement in order to achieve higher accuracy. The first stage absorption detection illuminates the sample under test with low intensity light to measure absorption and then switches the LEDs to a higher power output to induce photodegradation. The first stage absorption detection typically stabilizes in about thirty (30) seconds, and exposure to low levels of UV light at for longer intervals (less than three (3) minutes) does not produce a statistically significant change in the absorption measurement. Therefore, the short exposure to low-power UV light allows for a quick estimation based on absorption without altering the results of the following photodegradation measurement. This two stage approach makes the two measurements independent, and reduces the LED transient contributions to the photodegradation measurement. Following the first stage absorption detection, the second stage photodegradation detection immediately raises the optical power of the LEDs to levels needed for photodegradation and makes an absorption measurement based on the initial peak value of the output signal. The peak value is used to allow for the LED rise time, which leads to a faster initial estimate, although it would likely be less accurate than that in the first stage absorption detection. In addition, the second stage photodegradation measurement results could be available sooner as well, though the time reduction may not be a viable benefit given the longer control cycle times in a water cooling tower.

### EXAMPLES

The system and process for detecting phosphonates 10 disclosed herein is further illustrated by the following examples, which is provided for the purpose of demonstration rather than limitation.

### Example 1

### Ultraviolet Absorption in Mixtures of Phosphonate Samples and Iron (III):

An experiment of ultraviolet absorption in mixtures of phosphonate samples and iron (III) was conducted. Samples containing various concentrations of HEDP were mixed with solutions of Fe₂(SO₄)₃. The samples were illuminated by LEDs with wavelengths of 285 nm, 355 nm and 380 nm, and the optical power transmitted through the sample was measured by detectors sensitive to these wavelengths. The experiment investigated whether the transmission varied for HEDP concentrations of 1 mg/L, 5 mg/L, 10 mg/L and 20 mg/L in distilled water when blended with an iron (III) solution (3.6 μM). The HEDP and iron (III) solutions were mixed in a 3:1 ratio by volume. The transmission data was recorded over time by computer through data recording software and a data acquisition system.

The results at 385 nm with distilled water at 1 mg/L, 5 mg/L, 20 mg/L and 1000 mg/L are shown in FIG. 16A, and the results at 355 nm with distilled water at 1 mg/L, 5 mg/L, 20 mg/L and 1000 mg/L are shown in FIG. 16B. The data clearly shows that the transmitted power varies as a function of HEDP concentration for all of the wavelengths used, though more predominantly for the 355 nm (FIG. 16B) and 385 nm wavelengths (FIG. 16A), in large part due to the higher power available at these wavelengths. Experiments were also conducted with similar HEDP concentrations, prepared in both local tap water and in cooling tower water. Initial results from these experiments indicate that the dependence between the HEDP concentration and the detector output voltage continues to exist, though with different magnitude, under several different operating environments. The results in FIGS. 16A and 16B were taken with a resistor in parallel with the detector, which limited the dynamic range of the output voltages obtained.

In order to improve resolution, the experiment was repeated with the detectors placed under reverse bias using a resistor and a 6 V source. Additional phosphonate samples of 3, 7, and 17 mg/L were also obtained and included in the experiment to demonstrate that these intermediate concentration values could be reliably resolved. The results of these additional experiments are shown in FIGS. 17A and 17B. As can be seen, for concentrations at or below 17 mg/L, there is a clear progression in the output of the detector that correlates with the increase in HEDP concentration.

### Example 2

### Process for Detecting Phosphonate Using Absorption Detection:

The system and process for detecting phosphonate disclosed herein may utilize absorption detection to measure the UV absorbance (at low power, so that photodegradation is minimal) of phosphonate complexes at selected wavelengths. Measurement of the UV absorbance is accomplished as shown in FIG. 3. The sensors, meters or other electronics, such as those schematically illustrated in FIGS. 5 through 14, record the current produced by the detector in proportion to the power transmitted through the sample. The current is converted to a voltage by the electronics, and this voltage is compared to either (a) the power transmitted through air or a reference sample, or (b) the initial power available at the transmitter at the instance the measurement was taken.

Several key factors impact the effectiveness of the absorption detection methodology. These factors include the choice of source wavelength, the optical power available from the source, the beam shape (e.g., focused, collimated, etc.), the absorption spectra of different phosphonates that may be present within the sample, the phosphonate to iron (III) ratio and/or the presence of other compounds that absorb UV light within the sample. The wavelength or wavelengths chosen ideally correspond to UV bands where different phosphonate/iron complexes have absorption coefficients diverse enough to be able to distinguish which phosphonate compound is present in the sample in addition to the amount of compound that is present. Absorption at any wavelength can be enhanced by selecting the appropriate phosphonate to iron (III) ratio. In addition, using multiple wavelengths permits better resolution between different phosphonate compounds and may aid in the elimination of certain other compounds present in the sample that may absorb in only specific frequency bands. The absorption changes for different concentrations of the phosphonate compound are more easily distinguished for moderate to medium-high optical powers, since high optical power saturates the optical detector and low optical power does not provide sufficient dynamic range to accurately differentiate the different concentration levels. The power requirements are directly related to the choice of source and beam shape, since sources for some wavelength choices are only available with low power (less than 100 μW) outputs and thus require a focused beam to be suitable for use in the sensor, while other wavelength choices provide high power naturally and thus do not require additional optical components to be integrated into the sensor.

### Example 3

### Process for Detecting Phosphonate Using Photodegradation:

The system and method disclosed herein may also utilize photodegradation methodology based on the ability to degrade phosphonates into orthophosphates (PO₄³⁻) and AMPA upon exposure to an optical source. The illustrative example of a photodegradation sensor is shown in FIG. 4. In this example, water sampled from the cooling tower enters the sampling chamber and a small amount of iron (III) is added to the water. The iron (III) is added to enhance the UV absorption of the sample through the formation of Fe(III)/phosphonate complexes. A small area of the sample is then irradiated by the UV light source. As the UV radiation is absorbed, the phosphonate complexes degrade. To measure the rate at which the phosphonate complexes degrade, the first stage discussed above monitors the absorption of UV light with time, as shown in FIG. 3. As the complexes degrade, the structures that allow UV absorption will also degrade, and thus the absorbance of the sample at UV will decrease with time. An optical detector capable of collecting UV is placed opposite the UV source to monitor the optical power remaining after the light passes through the sample. As the absorbance decreases, the collected optical power is expected to increase. Measuring the initial absorbance and the rate of increase in the collected power provides information on the type and concentration of phosphonate(s) present in the sample.

As with the absorption detection discussed above in Example 2, there are several key factors that determine the effectiveness of the photodegradation methodology. These factors include availability and characteristics of UV sources for illuminating the sample. Ideally, the UV source used for the sensor of the system and process efficiently provides sufficient power at the appropriate wavelength(s) to rapidly degrade the phosphonate complexes without being cost prohibitive. Another factor includes verification of the change in absorption during photodegradation. As noted previously, the strong absorption in the UV is due to complexes formed by the phosphonates in the presence of iron (III). UV absorption that results in photodegradation is attributable to the absorption of the iron (III) coordinate covalent bond of the Fe (III)-phosphonate complex. As such, photodegradation can then be expected to result in a decrease in absorption of UV light over the range that results in the photodegradation reaction. Yet another factor includes the differentiation between different phosphonate types and concentrations. If multiple phosphonates are simultaneously present in a sample at different concentrations, mathematical analysis is required to separate (or approximately separate) the various degradation rates to estimate the concentrations of each phosphonate present. In addition, dependence of the photodegradation reaction on pH is another factor that determines the effectiveness of the photodegradation methodology. Photodegradation occurs most rapidly in samples with pH of acid to neutral, and as such, the pH present in the cooling tower must be accounted for in the sensor of the system and process disclosed herein. If samples commonly demonstrate a pH over 8, then compounds may need to be added to the samples to reduce the pH without impacting the phosphonate measurements to reduce the data collection time. Highly concentrated sulfuric acid (H₂SO₄) is one acid example that may be used for this purpose, but other appropriate acids may similarly be used.

### Example 4

Combined Absorption and Photodegradation Integrated into a Single Sensor:

As discussed above, an additional methodology for the system and process disclosed herein is to combine a first stage absorption detection and a second stage photodegradation detection into an integrated sensor. The first stage absorption detection provides a rapid initial assessment prior to the second stage photodegradation detection takes place and/or to monitor the final state of absorption after the photodegradation process has concluded. The photodegradation detection process requires a longer analysis time but provides better accuracy, especially when multiple phosphonate compounds and/or other UV absorbing compounds are present. Compounds that absorb in the UV may skew the results obtained from the absorption detection stage, but are ignored during the photodegradation stage, since the non-phosphonate compounds are not expected to degrade over time with exposure to UV radiation, and thus their contribution to the total absorption remain constant.

The longer analysis time of the photodegradation stage is not a limiting factor in its use, as the natural cycle in water cooling towers is quite long. After application of phosphonate compounds to treat the water in the tower, ten (10) to fifteen (15) minutes are required for the compounds to circulate and permeate throughout the volume of water in the tower. If the sensor of the system and process disclosed herein is designed such that the rate of photodegradation determined within approximately five (5) minutes of taking the sample from the tower, then sufficient data is available in time for the next control/treatment action to take place during the next treatment cycle.

For the absorption stage, the output signal is a constant voltage whose value should decrease as the phosphonate concentration increases for a given concentration of iron salts. The optical power is kept sufficiently low to minimize the effect of photo degradation. In effect, the photodegradation is sufficiently slow such that no appreciable reduction in absorption (corresponding to an increase in voltage) is observed during the measurement interval.

For the photodegradation stage, the output signal is a voltage that changes over time, ideally increasing over time as the Fe(III)/phosphonate (or other Fe/phosphonate) complexes breakdown and the absorption due to these complexes subsequently decreases. Both the rate of photodegradation and the extent of photodegradation are dependent on the phosphonate concentration. Therefore, the collected data comprises the rate of change of the voltage signal, which may include the rise time and/or the initial slope of the signal, and the amplitude change (maximum minus minimum) of the voltage signal. Using the change in signal amplitude, rather than the final value of the signal, eliminates errors that may arise when UV-absorbing compounds other than the complexes are present.

Whereas, the processes and systems have been described in relation to the drawings and claims, it should be understood that other and further modifications, apart from those shown or suggested herein, may be made within the scope of this invention.

What is claimed is:

1. A system for detecting phosphonate, said system comprising:
a sampling subsystem comprising a sampling chamber in fluid communication with a water cooling tower to extract a side stream to be used for a phosphonate concentration measurement; and
a processing subsystem comprising at least one optical source and a corresponding optical receiver capable of measuring transmitted optical energy through said side stream for said phosphonate concentration measurement.

2. The system of claim 1 further comprising a fresh water supply in fluid communication with said sampling chamber.

3. The system of claim 1 further comprising a set of electronically controlled solenoid valves in fluid communication with said side stream on an upstream side and a downstream side of said sampling chamber.

4. The system of claim 1 further comprising at least one mechanical fixture joined to said optical source and said optical receiver to ensure placement repeatability with respect to said sampling chamber.

5. The system of claim 1 wherein said optical source is a plurality of optical sources and said optical receiver is a plurality of optical receivers.

6. The system of claim 5 wherein each of said optical sources emit ultraviolet light at differing frequencies.

7. The system of claim 1 further comprising a reference signal for calibration.

8. The system of claim 7 wherein said reference signal is produced by onboard, auto calibration circuitry or manual calibration circuitry.

9. The system of claim 1 wherein said optical receiver has a powered reverse biased configuration.

10. The system of claim 1 wherein said optical source is an optimized LED source.

11. The system of claim 10 wherein said LED source emits at wavelengths of between about 285 nm and about 385 nm.

12. The system of claim 11 wherein said LED source is a plurality of optimized LED sources emitting at differing wavelengths of between about 355 nm and about 385 nm.

13. The system of claim 1 further comprising a temperature sensor to compensate for thermal effects within said sampling chamber.

14. The system of claim 1 further comprising an enclosure for said sampling subsystem and said processing subsystem.

15. The system of claim 1 further comprising a plurality of electrical relays to activate external devices.

16. The system of claim 1 further comprising at least one external interface.

17. The system of claim 1 further comprising a switch to set high and low limit parameters and/or timed operation parameters.

18. The system of claim 1 further comprising a microprocessor for control logic for said sampling subsystem and analysis logic for said processing subsystem.

19. The system of claim 1 further comprising at least one serial communication link.

20. The system of claim 1 wherein said system further comprises a first stage absorption detection subsystem and a second stage photodegradation detection subsystem.

21. A process for determining a phosphonate concentration in a water cooling tower, said process comprising the steps of:
extracting a water sample from a water cooling tower using a sampling subsystem;
mixing an iron salt with said water sample in said sampling subsystem;
illuminating said mixture of said iron salt and said water sample with optical energy using a processing subsystem; said optical energy having a predetermined intensity and at a predetermined wavelength; and
determining said phosphonate concentration using said processing subsystem based on photodegradation of said optical energy through said mixture.

22. The process of claim 1 further comprising the steps of:
detecting a first stage absorption of said mixture of said iron salt and said water sample using a low intensity optical energy from said processing subsystem;
subsequently, detecting a second stage photodegradation of said optical energy through said mixture using a high intensity optical energy from said processing subsystem.

23. The process of claim 2 wherein said low intensity optical energy has a wavelength between about 285 nm and about 355 nm and said high intensity optical energy has a wavelength between about 285 nm and about 385 nm.

24. The process of claim 1 wherein said predetermined wavelength is between about 285 nm and about 385 nm.

25. The process of claim 1 wherein said iron salt is an iron (III) salt.

26. The process of claim 1 further comprising:
said sampling subsystem comprising a sampling chamber in fluid communication with said water cooling tower to extract said water sample from a side stream; and
said processing subsystem comprising at least one optical source and a corresponding optical receiver for determining said photodegradation of said optical energy through said mixture.

27. The process of claim 1 wherein said step of illuminating said mixture further comprises the step of illuminating said mixture of said iron salt and said water sample with ultraviolet light at differing frequencies using an LED optical source of said processing subsystem.

28. The process of claim 7 wherein said LED optical source emits at wavelengths of between about 285 nm and about 385 nm.

29. The process of claim 8 wherein said LED optical source is a plurality of optimized LED optical sources emitting at differing wavelengths of between about 355 nm and about 385 nm.

30. The process of claim 1 further comprising the step of flushing said sampling subsystem with a supply of fresh water.
